(19) United States
(12) Patent Application Publication
(10) Pub. No.: US 2015/0223028 A1
(43) Pub. Date: Aug. 6, 2015

(54) Broadcast/Multicast Used for M2M/MTC

(71) Applicant: QUALCOMM Incorporated, San Diego, CA (US)

(72) Inventors: Jun Wang, Poway, CA (US); Carlos M. D. Pazos, Carlsbad, CA (US); Sivaramakrishna Veerepalli, San Diego, CA (US); Dilip Krishnaswamy, Roseville, CA (US); Xipeng Zhu, Beijing (CN); Miguel Griot, La Jola, CA (US); Farrokh Khatibi, San Diego, CA (US); Arungundram Chandrasekaran Mahendran, San Diego, CA (US)

(21) Appl. No.: 14/425,304

(22) PCT Filed: Oct. 3, 2012
(86) PCT No.: PCT/CN2012/082520

§ 371 Date: Mar. 2, 2015

(51) Int. Cl. H04W 4/06; H04W 4/00

(52) U.S. Cl. CPC H04W 4/06; H04W 4/005; H04L 12/189

(57) ABSTRACT

A method, an apparatus, and a computer program product for wireless communication are provided. An apparatus notifies a user equipment (UE) of an upcoming multicast/broadcast of data intended for receipt by a group of UEs assigned a machine type communication (MTC) class. The UE has one or more MTC classes assigned to it and is configured to awake for the upcoming multicast/broadcast of data if the data to be broadcast corresponds to an MTC class assigned to the UE. The apparatus also multicasts/broadcasts the data intended for receipt by a group of UEs through at least one multicast/broadcast mechanism.

### BACKGROUND

1. Field

The present disclosure relates generally to communication systems, and more particularly, to broadcast/multicast services for machine-to-machine (M2M) and machine type communications (MTC).

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

In an aspect of the disclosure, a method, a computer program product, and an apparatus are provided. An apparatus notifies a user equipment (UE) of an upcoming multicast/broadcast of data intended for receipt by a group of UEs assigned a machine type communication (MTC) class. The UE has one or more MTC classes assigned to it and is configured to awake for the upcoming multicast/broadcast of data if the data to be broadcast corresponds to an MTC class assigned to the UE. The apparatus also multicasts/broadcasts the data intended for receipt by a group of UEs through at least one multicast/broadcast mechanism.

In another aspect of the disclosure, an apparatus receives a notice of an upcoming multicast/broadcast of data intended for receipt by a group of UEs assigned a MTC class. The apparatus has one or more MTC classes assigned to it and is configured to awake for the upcoming multicast/broadcast of data if the data to be broadcast corresponds to an MTC class assigned to the UE. The apparatus also receive a multicast/broadcast of the data intended for receipt by a group of UEs through at least one multicast/broadcast mechanism.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7 is a diagram illustrating evolved Multimedia Broadcast Multicast Service in a Multicast Broadcast Single Frequency Network.

FIG. 8 is a diagram illustrating a first CBS/PWS architecture used data downloading.

FIG. 9 is a diagram illustrating a second CBS/PWS architecture used data download.

FIG. 10 is a diagram illustrating a first MTC architecture using eMBMS for data/content downloading.

FIG. 11 is a diagram illustrating the first MTC architecture of FIG. 10 using CBS/PWS for UE group notification/triggering.

FIG. 12 is a diagram illustrating a second MTC architecture using eMBMS for data/content downloading and for UE group notification/triggering.

FIG. 13 is a diagram illustrating an exemplary call flow performed by the MTC architecture of FIG. 12.

FIG. 14 is a diagram illustrating MTC architecture using eMBMS.

FIG. 15 is a flow chart of a method of wireless communication involving a multicast/broadcast mechanism.

FIG. 16 is a conceptual data flow diagram illustrating the data flow between different modules/means/components in an exemplary apparatus that implements the method of FIG. 15.

FIG. 17 is a diagram illustrating an example of a hardware implementation for an apparatus employing a processing system implements the method of FIG. 15.

FIG. 18 is a flow chart of a method of wireless communication involving a UE.

FIG. 19 is a conceptual data flow diagram illustrating the data flow between different modules/means/components in an exemplary apparatus that implements the method of FIG. 18.

FIG. 20 is a diagram illustrating an example of a hardware implementation for an apparatus employing a processing system that implements the method of FIG. 18.

FIG. 21 is a diagram illustrating an architecture for broadcast delivery to a number of M2M devices without a response from the devices.

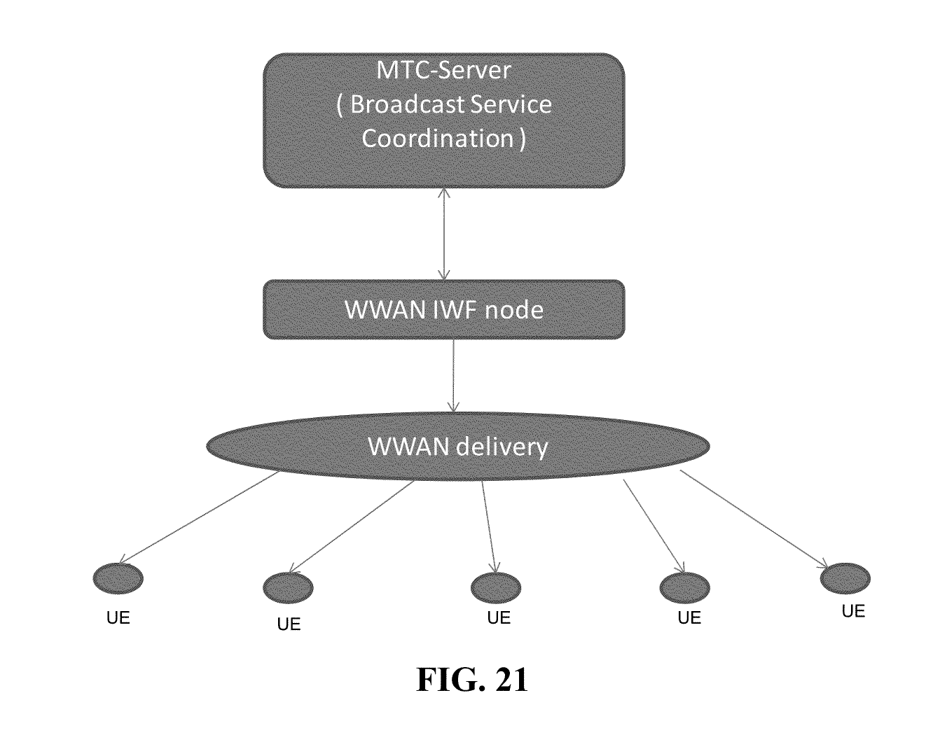

FIG. 22 is a diagram illustrating an architecture for broadcast delivery to a number of M2M devices with unicast responses from the devices and rebroadcast management.

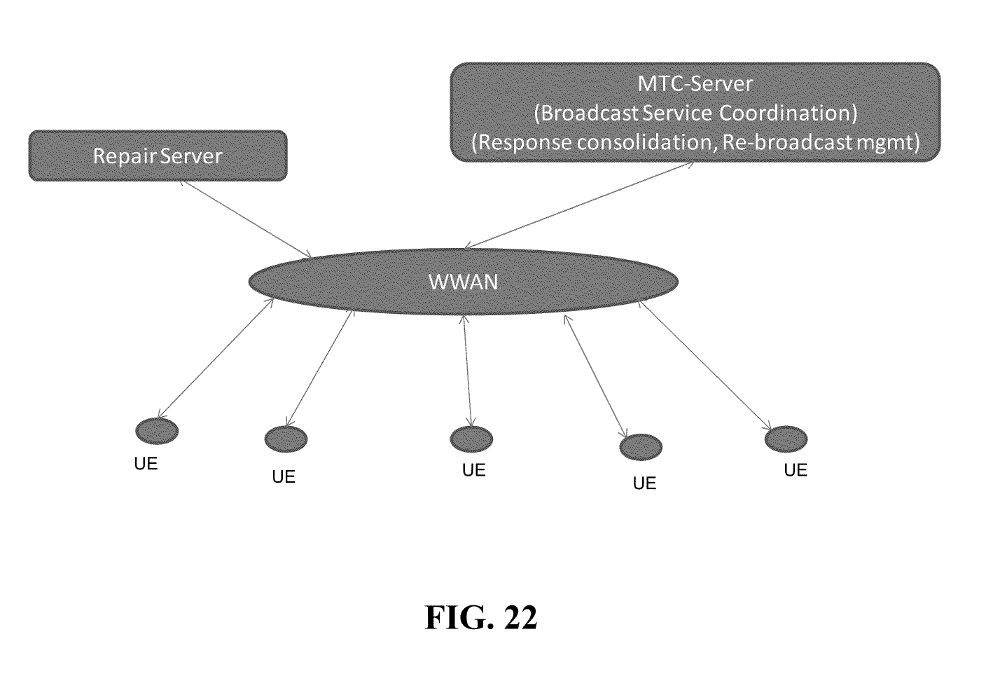

FIG. 23 is a diagram illustrating another architecture for broadcast delivery to a number of M2M devices with unicast responses from the devices and rebroadcast management.

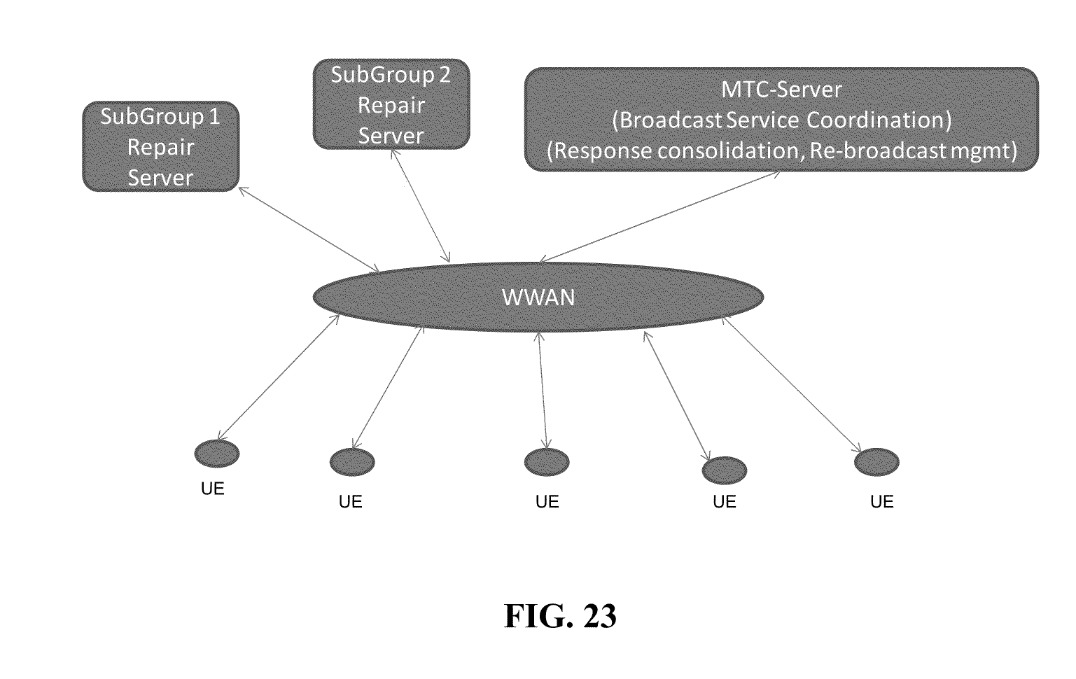

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

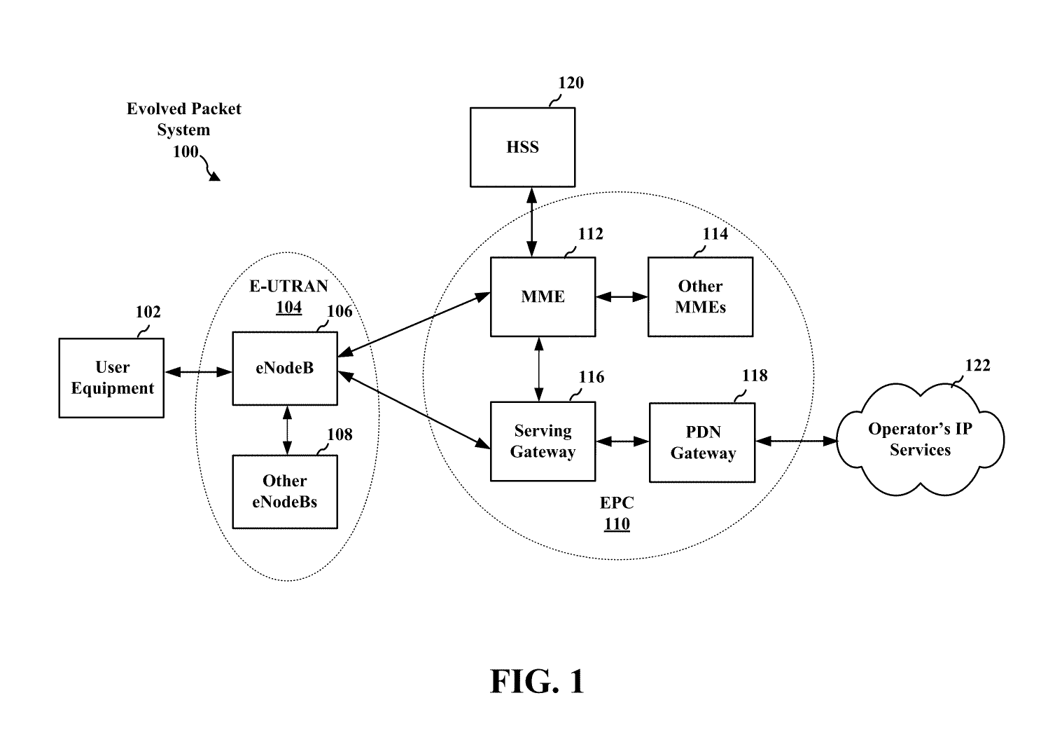

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control planes protocol terminations toward the UE 102. The eNB 106 may be connected to the other eNBs 108 via a backhaul (e.g., an X2 interface). The eNB 106 may also be referred to as a base station, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected by an S1 interface to the EPC 110. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, the Intranet, an IP Multimedia Subsystem (IMS), and a PS Streaming Service (PSS).

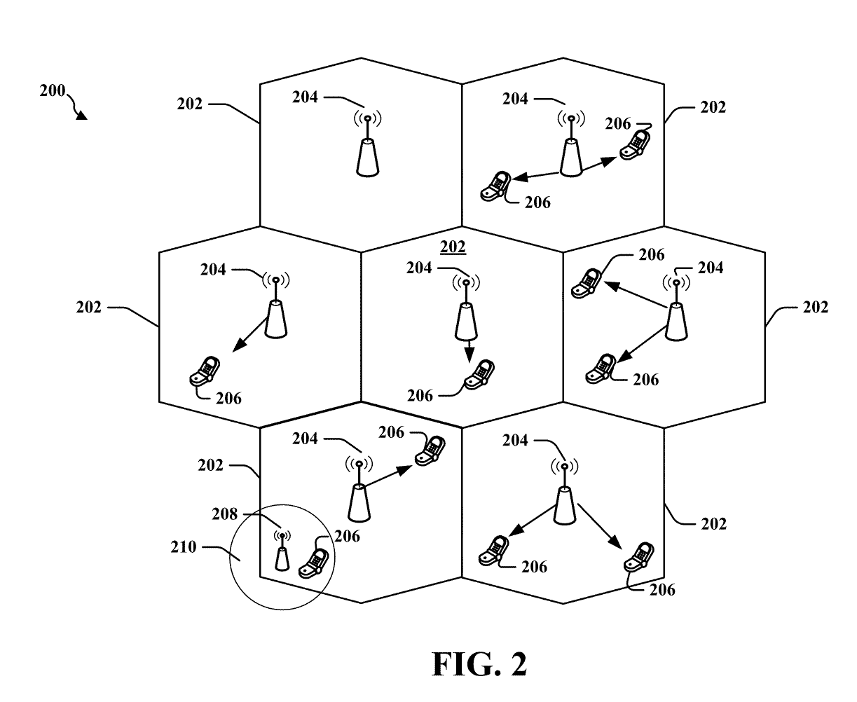

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

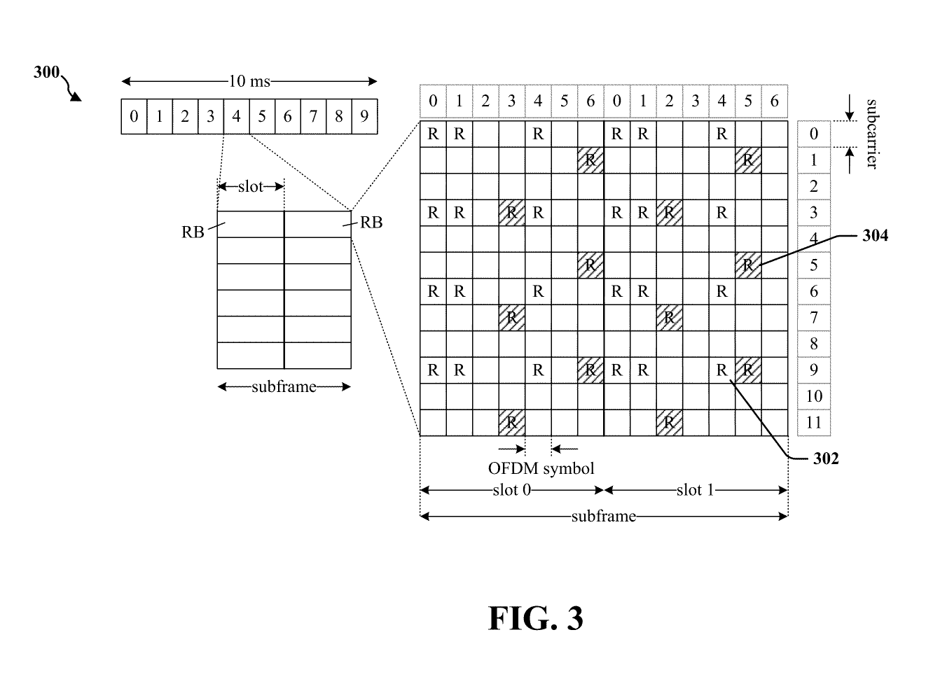

FIG. 3 is a diagram 300 illustrating an example of a DL frame structure in LTE. A frame (10 ms) may be divided into 10 equally sized sub-frames. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

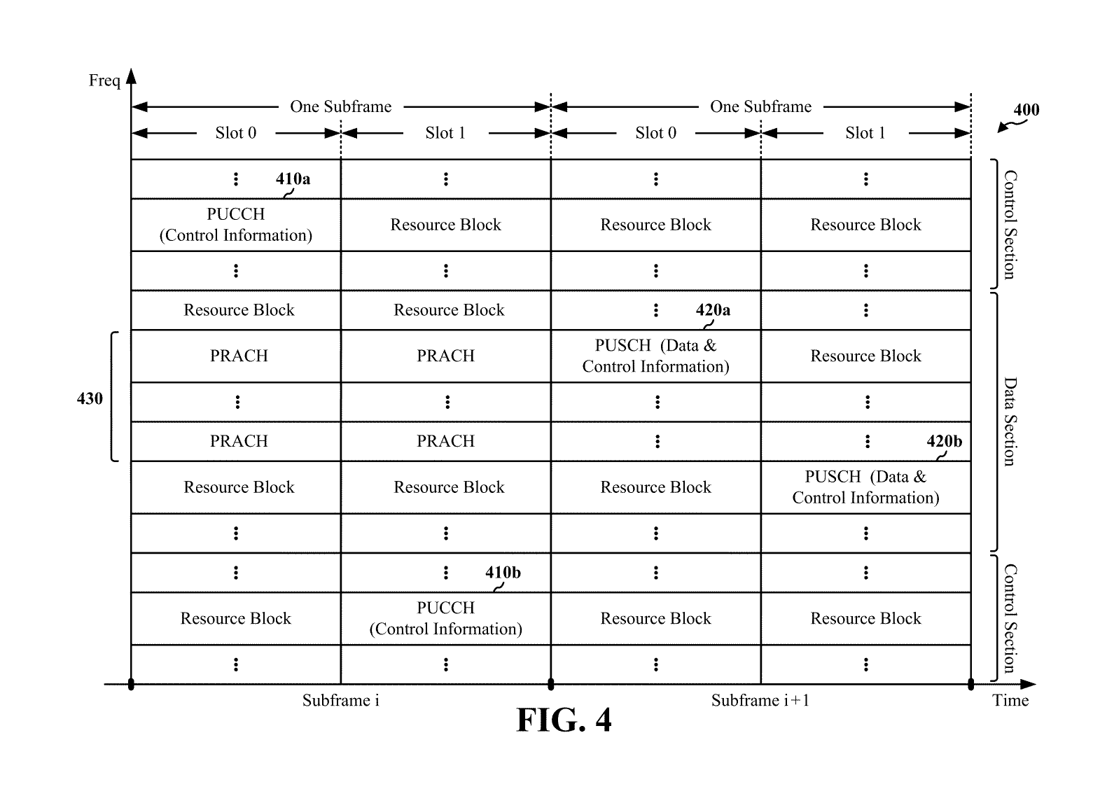

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

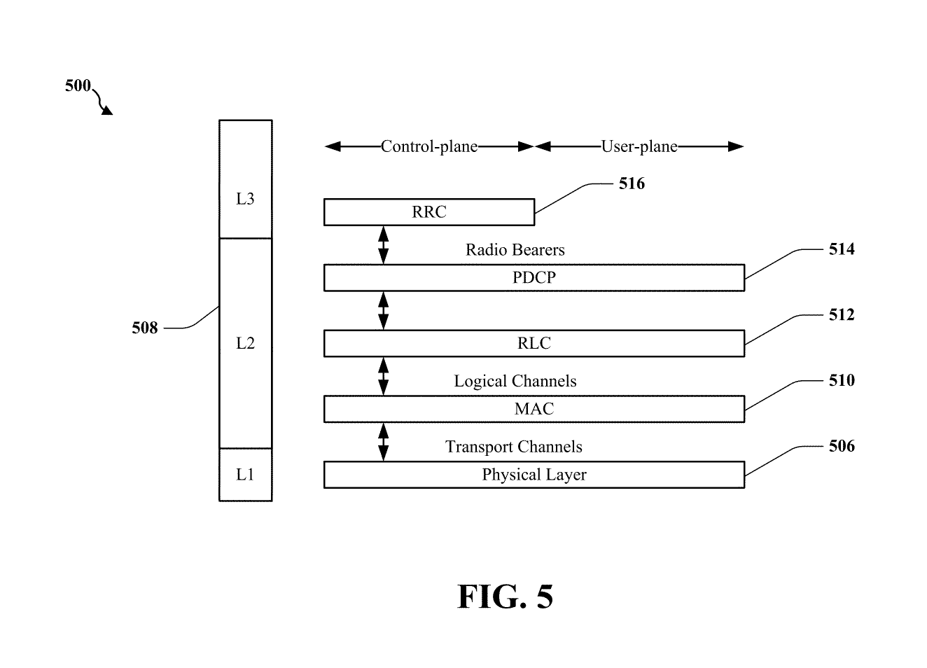

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNB and the UE.

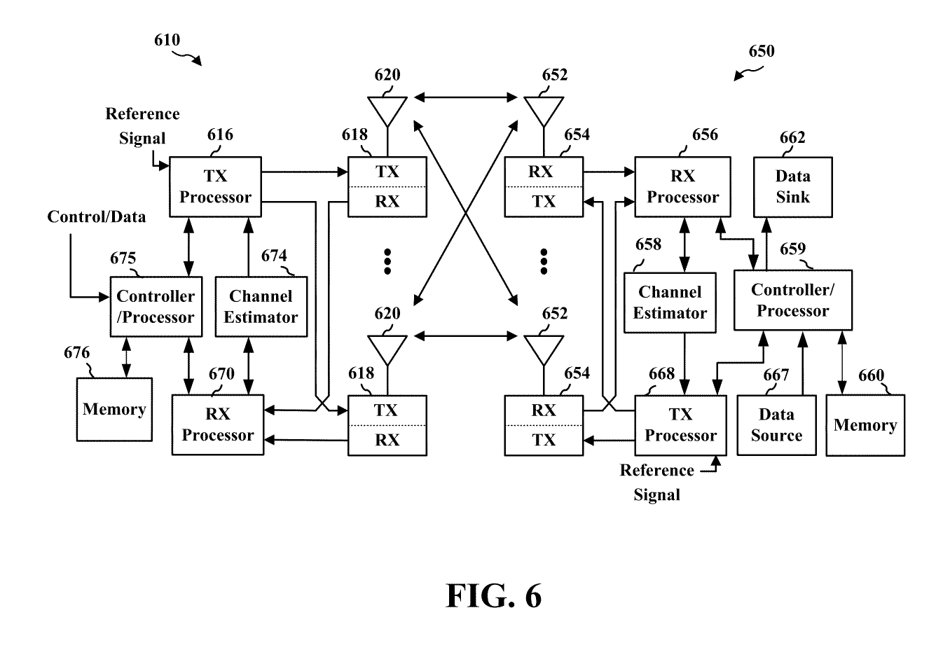

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

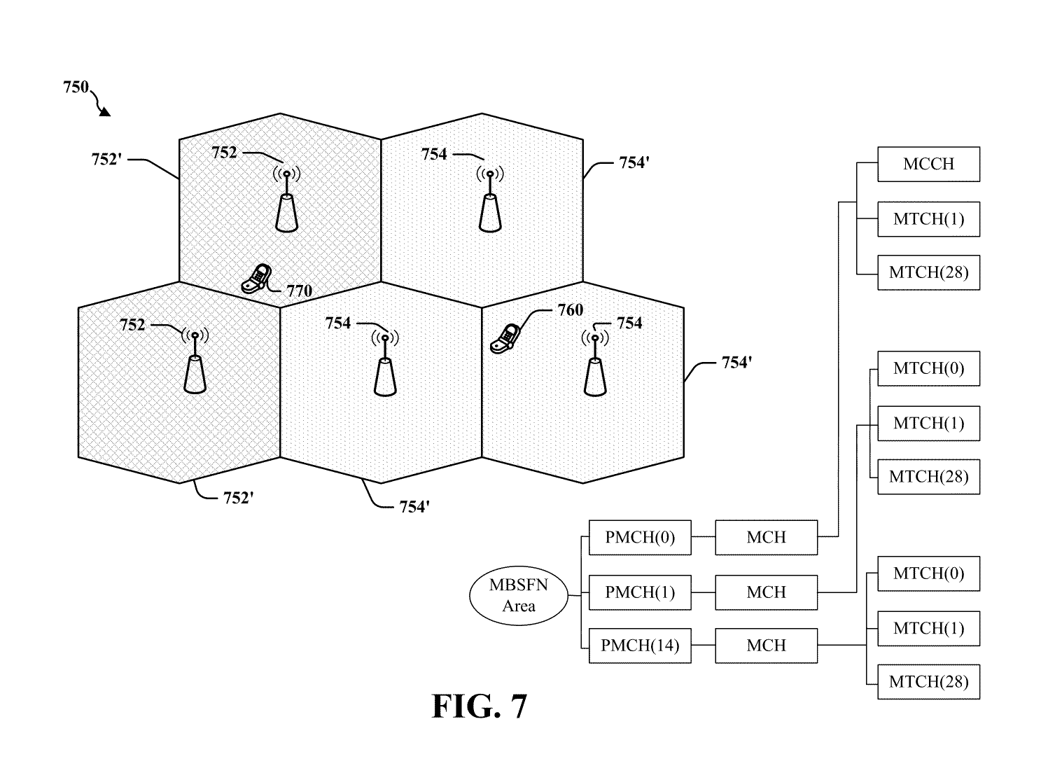

FIG. 7 is a diagram 750 illustrating evolved Multimedia Broadcast Multicast Service (eMBMS) in a Multicast Broadcast Single Frequency Network (MBSFN). The eNBs 752 in cells 752′ may form a first MBSFN area and the eNBs 754 in cells 754′ may form a second MBSFN area. The eNBs 752, 754 may each be associated with other MBSFN areas, for example, up to a total of eight MBSFN areas. A cell within an MBSFN area may be designated a reserved cell. Reserved cells do not provide multicast/broadcast content, but are time-synchronized to the cells 752′, 754′ and have restricted power on MBSFN resources in order to limit interference to the MBSFN areas. Each eNB in an MBSFN area synchronously transmits the same eMBMS control information and data. Each area may support broadcast, multicast, and unicast services. A unicast service is a service intended for a specific user, e.g., a voice call. A multicast service is a service that may be received by a group of users, e.g., a subscription video service. A broadcast service is a service that may be received by all users, e.g., a news broadcast.

Referring to FIG. 7, the first MBSFN area may support a first eMBMS broadcast service, such as by providing a particular news broadcast to UE 770. The second MBSFN area may support a second eMBMS broadcast service, such as by providing a different news broadcast to UE 760. Each MBSFN area supports a plurality of physical multicast channels (PMCH) (e.g., 15 PMCHs). Each PMCH corresponds to a multicast channel (MCH). Each MCH can multiplex a plurality (e.g., 29) of multicast logical channels. Each MBSFN area may have one multicast control channel (MCCH). As such, one MCH may multiplex one MCCH and a plurality of multicast traffic channels (MTCHs) and the remaining MCHs may multiplex a plurality of MTCHs.

Broadcast/multicast mechanisms are more efficient when the same machine type communications (MTC) data or machine-to-machine (M2M) data are to be sent to a group of user devices. One such broadcast/multicast mechanism is cell broadcast service/public warning system (CBS/PWS). The CBS/PWS includes the earthquake and tsunami warning system (ETWS) and the commercial mobile alert service (CMAS). The CBS/PWS mechanism is suitable for small text data download and does not require device triggering. “Device trigger” as used herein refers generally to the concept of waking a device, e.g. UE, from an idle or sleeping state in order to receive data. Another broadcast/multicast mechanism is the multimedia broadcast multicast service (MBMS)/and evolved (eMBMS) for LTE, as described above with reference to FIG. 7. This mechanism is suitable for multimedia data download, and typically relies on device triggering.

Broadcast/multicast of MTC/M2M data may be scheduled or unscheduled. In scheduled broadcasts, the broadcast/multicast mechanism broadcasts in accordance with a preset schedule and the user device, aware of that schedule, receives the broadcast data. An example of a scheduled data broadcast includes daily or weekly downloads of newspaper articles. In cases of unscheduled broadcasts, neither the broadcast mechanism nor the user device knows in advance when a broadcast will occur. In this case, the broadcast/multicast mechanism is triggered into broadcasting the data and the user device is triggered into receiving the data. Examples of unscheduled data broadcasts include device software and firmware updates and common commands or messages to a large number of devices to initiate an action (e.g., turn on/off street lights, message to smart meters to get report on a dynamic basis etc).

A drawback with current multicast/broadcast mechanisms is that whenever data is broadcast/multicast the user device wakes up whether or not the data being sent is intended for it. To address this drawback, mechanisms described herein introduce concepts that allow user devices to wake up only when data intended to be received by the device is being broadcast. To this end, mechanisms disclosed herein involve assignment of one or more classes to a user device. These classes, as described further below, may include a hierarchical organization of categories, groups, sub-groups and/or sub-sub-groups. These classes, in combination with CBS/PWS and eMBMS mechanisms, allow for user devices to awake only when data associated with one of its assigned classes is being multicast/broadcast.

User devices may be preconfigured with class assignments. Classes, defined for example, by MTC category or group IDs, may be assigned via MTC service registration and request. The MTC category can be smart grid, health care, etc. The MTC group ID may be assigned for each MTC group including category information. For example Group ID1 may be San Diego Gas and Electric (SDGE) meter readers. Categories/group IDs can be assigned to devices through a paging message, for example, under CMAS-indication, CMAS-indication-Group-X and CMAS-indication-Group-Y may be added. In another example, MTC-Indication and MTC-Indication-Group x may be added and a new SIB for MTC introduced. In yet another example, eMBMS-indication or further eMBMS-indication-Group-x and eMBMS-indication-Group-y (currently systemInfoModification indicates any broadcast control channel (BCCH) modification other than SIB10/11/12) may be added.

As mentioned above, class assignments may be hierarchical and include a first tier, category/group assignment through a paging message followed by a second tier, subgroup assignment by SIB. Currently all UEs capable of CBS/PWS wake up whenever there is a change in SIB10, SIB11 or SIB12. Therefore, MTC category and/or group assignments may be included in SIB10, SIB11 or SIB12.

For multicast/broadcast employing eMBMS/MBMS mechanisms, it would be beneficial to introduce user service description (USD) change period (including period for certain category/group) so that the user device does not need to wake up frequently to check USD update. The device only wakes up during the change period. MTC category and/or group may be included under the service class in USD, or may be added to SIB13.

Regarding scheduling of broadcasts/multicasts using CBS/PWS mechanisms, UE battery life would be conserved if the UE knew its group schedule. To this end, schedule information may be sent through unicast, USD or CBS/PWS itself. Regarding scheduling in MBMS/eMBMS, a proprietary blob may be included in USD for each category and/or group. Instead of a common schedule for each group, each group will have a unique schedule.

Current SIBs and channels relevant to the above outlined multicast/broadcast enhancements include: SIB10, which contains an earthquake and tsunami warning system (ETWS) primary notification; SIB11, which contains an ETWS secondary notification; SIB12, which contains a commercial mobile alert service (CMAS) notification; and SIB13, which contains the information required to acquire the MBMS control information associated with one or more MBSFN areas. ETWS and/or CMAS capable UEs in RRC_CONNECTED read paging at least once every defaultPagingCycle to check whether ETWS and/or CMAS notification is present or not. The paging message includes the ETWS-Indication and CMAS-Indication. The master information block (MIB) is sent over the physical broadcast channel (PBCH) and all system information blocks (SIBs) and paging are sent over the physical downlink shared channel (PDSCH).

As mentioned above, in order to multicast/broadcast data to a group of user devices, the devices are associated with an MTC class, i.e., a category having one or more associated groups, sub-groups and/or sub-sub groups, corresponding to data intended for receipt by the group of UEs. Within each category a hierarchy of group IDs may exist. For example, as shown in the table below, MTC categories may include consumer electronics (CE), healthcare, automotive and metering. Each category has an assigned group ID. A group ID may have one or more associated sub-group IDs and a sub-group ID may have one or more associated sub-sub-group IDs.

| M2M | | | Sub-Sub- |
|---|---|---|---|
| Categories | Group ID | Sub-Group ID | GroupID |
| Consumer | M2M-CE | M2M-CE-Alarms | |
| Electronics | | M2M-CE-Cameras | |
| | | M2M-CE-Tracking | |
| | | M2M-CE-Gadget | |
| Healthcare | M2M-Health | M2M-Health- | |
| | | WWANGateway | |
| | | M2M-Health- | |
| | | EmbeddedWWAN | |
| | | M2M-Health-Smartphone | |
| | | M2M-Health-CareProvider | |
| Automotive | M2M-Auto | M2M-Auto-Telematics | |
| | | M2M-Auto-HeadUnit | |
| | | M2M-Auto-EVChargers | |
| Metering | M2M-Meter | M2M-Meter-Home | M2M-Meter- |
| | | M2M-Meter-Enterprise | Home-Electric |
| | | M2M-Meter-Commercial | M2M-Meter- |
| | | | Home-Gas |
| | | | M2M-Meter- |
| | | | Home-Water |

A user device may be associated with one or more group IDs, sub-group IDs or sub-sub-group IDs such that the device is set up to receive broadcast/multicast data corresponding to one or more of the IDs. For ease in further description, the term “group ID,” is intended to encompass all levels of ID, including group, sub-group and sub-sub-group.

Group IDs may be allocated by an operator or a service provider. For example, in the case of an operation, mobile country code/mobile network code (MCC/MNC) can be included in group ID, and in the case of a service provider, MCC/Service provider ID can be included in Group ID. Group IDs may also be allocated by a M2M international forum, such as OneM2M.

Group ID assignment to user devices may occur through preconfiguration or through online assignment. In the case of preconfiguration, a device may register its group ID with an MTC server during MTC service registration. In cases of online assignment, the MTC server may assign a group ID to the device during MTC service registration. Also, an operator may assign a group ID during attach procedures, in which case the device subsequently registers its assigned group ID with the MTC server during MTC service registration.

Multicast/Broadcast Using CBS/PWS:

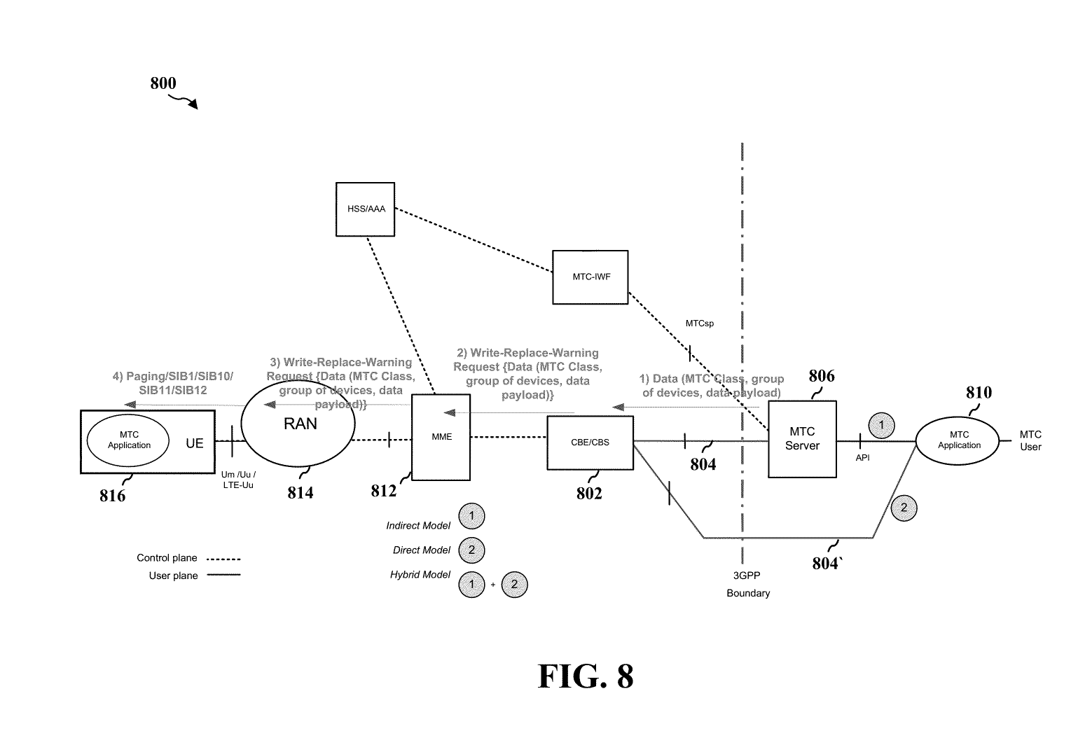

FIG. 8 is a diagram 800 illustrating a first CBS/PWS architecture used for multicast/broadcast data downloading. In this multicast/broadcast mechanism, a cell broadcasting entity (CBE)/CBS 802 is used for data downloading. A set of data 804 is sent from a MTC server 806 to the CBE/CBS 808. Alternatively, the set of data 804′ may be sent from a MTC application 810. This set of data 804, 804′ includes data identifying a MTC class, including relevant groups IDs, associated with the data to be multicast/broadcast. The data set 804, 804′ further includes the data that is to be multicast/broadcast.

The CBE/CBS 802, in turn, sends the set of data 804, 804′ directly to a mobility management entity (MME) 812 using the write-replace-warning request protocol (TS 23.041). The MME 812 then sends the set of data 804, 804′ to a radio access network (RAN) 814. The RAN 814 notifies user devices, now on referred to as UEs 816, within the group of an upcoming data multicast/broadcast. Such notification may be through a group ID included in a paging message sent to the UEs 816 or in SIB1. For example, in a paging message the group ID may be represented by an ETWS-Indication or a CMAS-Indication. Upon receipt of such notification, the UEs 816 wake up and receive a multicast/broadcast schedule, which is also sent by the RAN 814. This schedule may be received, for example, through SIB1. In accordance with the received schedule, the RAN 814 multicasts/broadcasts the data on one or more of SIB10, SIB11 and SIB12, and the UEs 816 receive the data.

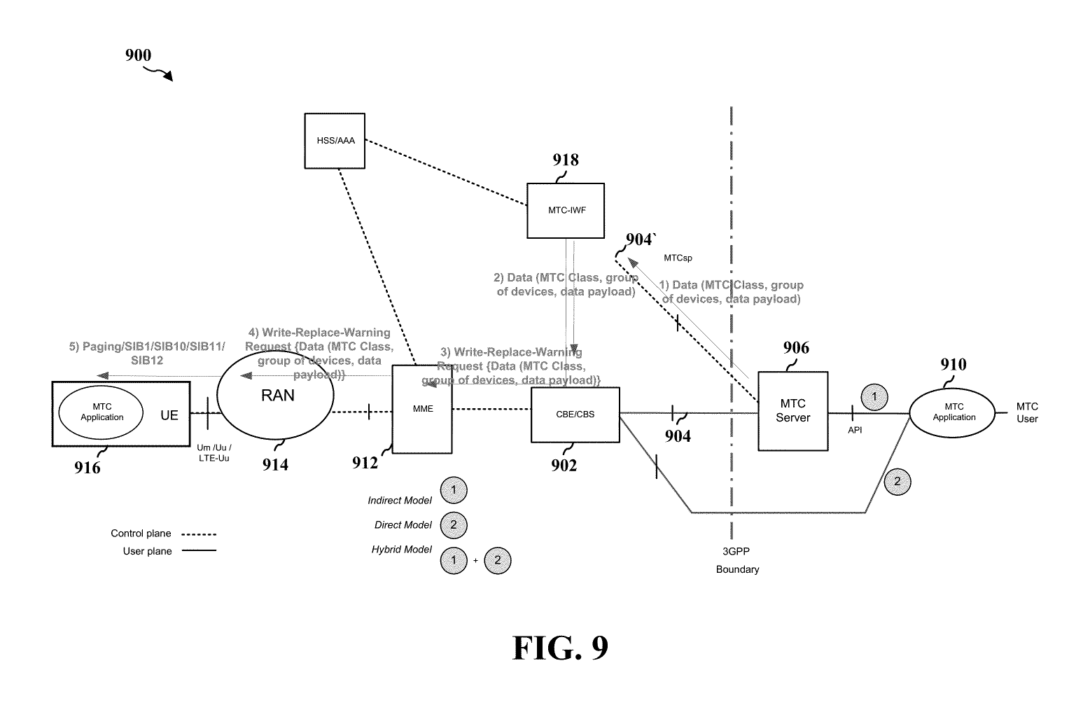

FIG. 9 is a diagram illustrating a second CBS/PWS architecture used for multicast/broadcast data download. In this downloading mechanism, a CBE/CBS 902 is used for data downloading. A set of data 904 is sent from a MTC server 906 directly to a MTC interworking function (MTC-IWF) 918 instead of directly to the CBE/CBS 902, as done in the mechanism of FIG. 8. The set of data 904 is sent to the MTC-IWF 918 in cases where the MTC server 906 does not have any information with respect to the UEs 916 for which the data is intended. In other words, the MTC server 906 does not know which UEs have group IDs corresponding to the group ID of the data to be multicast/broadcast.

The set of data 904 includes data identifying a MTC class, including relevant groups IDs, associated with the data to be multicast/broadcast. The data set 904 further includes the data that is to be multicast/broadcast. The data set 904 may also include a device trigger. The MTC-IWF 918 includes mapping information that maps the data to be multicast/broadcast to one or more CBE/CBSs 902 and associated RANs 914 within target range of the UEs assigned to the group ID. Based on this mapping information, the MTC-IWF 918 sends the data to the appropriate CBE/CBS 902. Communication from the MTC server 906 to the MTC-IWF 918 gives more flexibility in the architecture in terms of group IDs that are being used for UEs. They could be group IDs that are associated with the interim application at the MTC application 910 or MTC server 906 level. Mapping between what the interim application is targeting verses what device the RAN needs to target may be necessary.

The set of data 904 can also include a duration of time T over which the UEs can respond or send an acknowledgement over a unicast connection to the MTC server, if a response is desired. The UEs can stagger their responses during this duration T, so as to distribute the load associated with the unicast accesses of the UEs over that period of time, so that the network does not get congested. The set of data 904 can also include the IP address of an alternate server to which the UEs can communicate with, to attempt a file repair associated with the information received. The MTC server 906 can further attempt to target subgroups of UEs at a time, to prioritize the groups in sequence. For example, in a smart grid case, for a demand response scenario with a request for load shedding, a higher priority group can be targeted first, followed by lower priority groups. For example, the MTC_Meter_Enterprise group may be a higher priority group than MTC_Meter_Home group, because an enterprise may be able to shed more load than an individual home, when requested. In this case, the MTC server 906 suggests a time Tᵢ to each subgroup i, in the set of data 904. The MTC server 906 targets each subgroup i (or subsubgroups as the case may be), in sequence, to distribute the unicast response load on the network from the UEs. Alternatively, the MTC server 906 may send a multi-class (or multi-group) broadcast message to the MTC-IWF 918 or directly to the CBE/CBS 902, such as <B1, C1, T1, C2, T2, C3, T3, . . . > where B1 is a broadcast message identifier, C1, C2, C3 are different prioritized groups of devices, in order of decreasing priority and T1, T2 and T3 are times, where T1<T2<T3. Devices with priority group/class C1, can respond in time t where 0<t<T1, devices with priority class C2 can respond in time t where T1<t<T2, and devices with priority class C3 can respond in time t where T2<t<T3. The CBE/CBS 902 can then target each MTC group/class with separate broadcast messages separated in time to distribute the unicast response load on the network. It is also possible that multiple subgroups are targeted simultaneously, where such subgroups may target different repair servers, to distribute the load on the repair servers. Additional description of the forgoing broadcast support concept for M2M devices is provided further below under the Broadcast Support for M2M section.

The CBE/CBS 902, in turn, sends the set of data 904 to the MME 912 using the write-replace-warning request protocol (TS 23.041). The MME 912 then sends the set of data 904 to the RAN 914. The RAN 914 notifies UEs 916 within the group of an upcoming data multicast/broadcast. Such notification may be through a group ID included in a paging message sent to the UEs 916 or in SIB1. Upon receipt of such notification, the UEs 916 wake up and receive a multicast/broadcast schedule, which is also sent by the RAN 914. This schedule may be received, for example, through SIB1. In accordance with the received schedule, the RAN 914 broadcasts the date on one or more of SIB10, SIB11 and SIB12, and the UEs 916 receive the data.

FIG. 8 and FIG. 9 thus represent two similar CBS/PWS architectures for multicasting/broadcasting data. The first architecture of FIG. 8 assumes mapping information is resident in the CBE/CBS. In the second architecture, mapping information is not resident in the CBE/CBS and is obtained through the MTC-IWF.

Multicast/Broadcast Using MBMS/eMBMS:

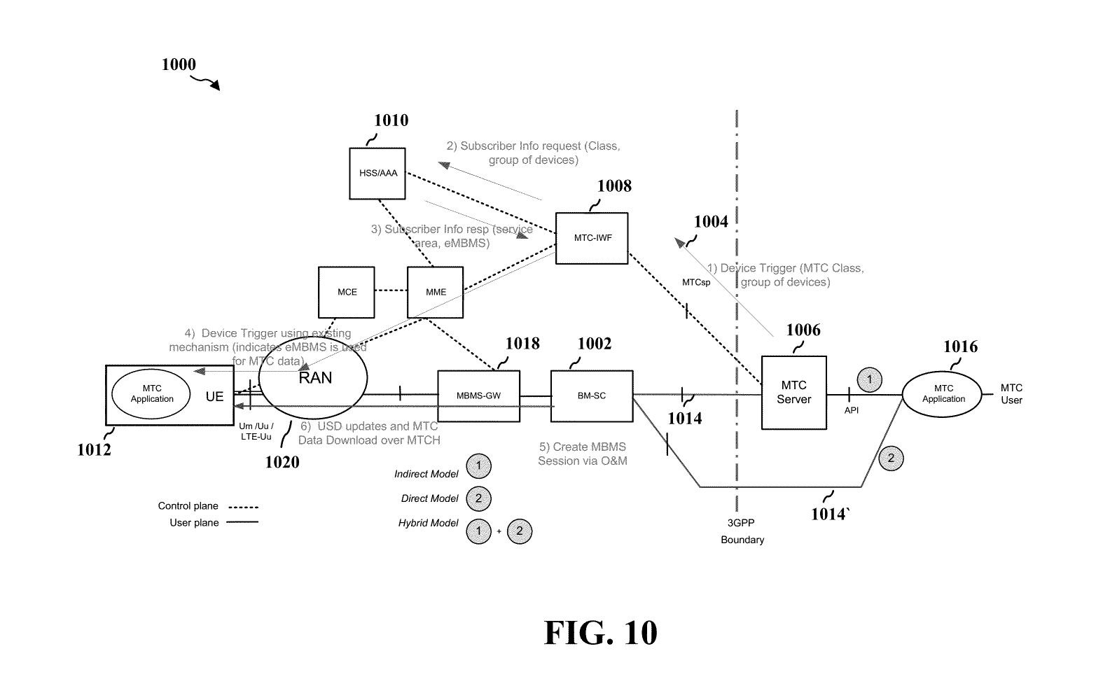

FIG. 10 is a diagram illustrating a first MTC architecture using eMBMS for data downloading. In this multicast/broadcast mechanism, a BM-SC 1002 is used for data downloading. In the case of an unscheduled download, a device trigger 1004 is sent from a MTC server 1006 to a MTC-IWF 1008. The MTC-IWF 1008 requests subscription information from a HSS/AAA 1010 to know where to send and to get mapping information. The HSS/AAA 1010 sends subscription information to the MTC-IWF 1008. The MTC-IWF 1008 sends the device trigger 1004′ to the UEs 1012 through the RAN 1014. The device trigger 1004′ is sent to the UEs 1012 using existing mechanisms, such as a unicast channel device trigger mechanism, and provides an indication that eMBMS is being used to multicast/broadcast the data.

Data 1014, 1014′ to be downloaded is sent from the MT server 1006 or MTC application 1016 to the BM-SC 1002. The BM-SC 1002 sends the data directly to the MBMS gateway (MBMS-GW) 1018. The MBMS-GW 1018 then sends the data to the radio access network (RAN) 1020. The RAN 1020 notifies the UEs 1012 within the group of an upcoming data multicast/broadcast, in which case the UEs 1012 read USD updates for download information and the multicast traffic channel (MTCH) for the data 1014, 1014′ being downloaded.

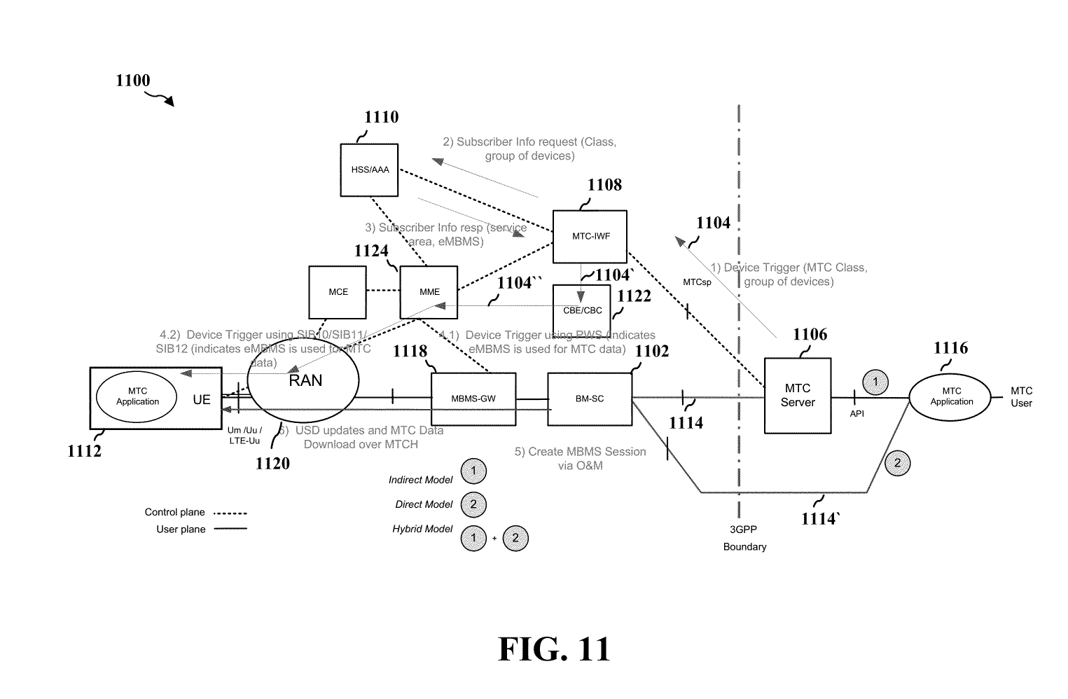

FIG. 11 is a diagram illustrating the first MTC architecture of FIG. 10 using CBS/PWS for group notification/triggering. In this multicast/broadcast mechanism, a BM-SC 1102 is used for data downloading. A device trigger 1104 is sent from a MTC server 1106 to a MTC-IWF 1108. The MTC-IWF 1108 requests subscription information from the HSS/AAA 1110 to know where to send and to get mapping information. The HSS/AAA 1110 sends subscription information to the MTC-IWF 1108. The MTC-IWF 1108 sends the device trigger 1104′ to the CBE/CBS 1122, which in turn send the device trigger 1104″ to a MME 1124, which in turn send the device trigger to a RAN 1120. The device trigger is sent using SIB10, SIB11 or SIB12, and provides an indication that eMBMS is being used to multicast/broadcast the data.

Data 1114, 1114′ to be downloaded is sent from the MTC server 1106 or MTC application 1116 to the BM-SC 1102. The BM-SC 1102 sends the data 1114, 1114′ directly to a MBMS-GW 1118. The MBMS-GW 1118 then sends the data to the RAN 1120. The RAN 1120 notifies UEs 1112 within the group of an upcoming data multicast/broadcast, in which case the UEs read USD updates for download information and the MTCH for the data being downloaded.

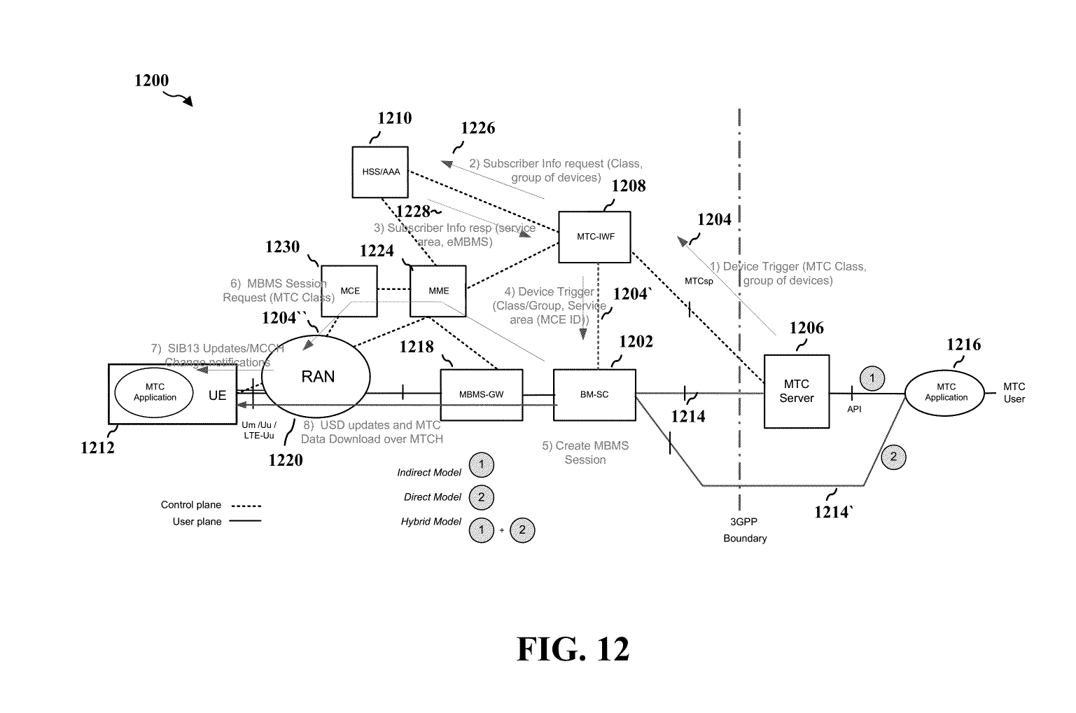

FIG. 12 is a diagram illustrating a second MTC architecture using eMBMS for data downloading and for group notification/triggering. In this architecture, eMBMS is used for both device triggering and content downloading, a BM-SC 1202 is used for data downloading and a direct interface between the MTC-IWF 1208 and BM-SC 1202 is used to create MBMS sessions and send device triggers. A device trigger 1204 is sent from a MTC server 1206 to the MTC-IWF 1208 indicating the device trigger and that data intended for UEs associated with a particular data class will be sent. The MTC-IWF 1208 sends a request for subscription information 1226 to the HSS/AAA 1210 to know where to send and to get mapping information. The MTC-IWF 1208 queries with HSS/AAA 1210 to decide that eMBMS should be used as a transport mechanism for the device trigger and MTC data download. The HSS/AAA 1210 sends subscription information 1228 to the MTC-IWF 1208.

The MTC-IWF 1208 sends the device trigger 1204′ directly to the BM-SC 1202 and contacts the BM-SC 1202 to request to add a MBMS session with group ID. The BM-SC 1202 creates a MBMS download session. Once the session is created the eMBMS sends the device trigger 1204″ to the UEs 1212 through the MME 1224 and MCE 1230 components of the eMBMS and the RAN 1220, while at same time sending the data to the UE 1212 through the MBMS-GW 1218 of the eMBMS. The UEs 1212 wake up to read SIB13, MCCH changes and the USD. After that the data is downloaded over MTCH.

Data 1214, 1214′ to be downloaded is sent from the MT server 1206 or MTC application 1216 to the BM-SC 1202. The BM-SC 1202 sends the data directly to the MBMS-GW 1218. The MBMS-GW 1218 then sends the data RAN 1220. The RAN 1220 notifies UEs 1212 within the group of an upcoming data multicast/broadcast, in which case the UEs read USD updates for download information and the MTCH for the data being downloaded.

This architecture may use SIB13 for group device triggering. The SIB13 includes a new DeviceCategory/Group ID and ChangeCount IE. As described above, different DeviceCategory/Group ID values are assigned to different applications/groups. ChangeCount can be used to indicate if a UE needs to check USD because SIB13 change could be because MCCH configuration change. The DeviceCategory/Group ID is also added as a new attribute to the user service description (USD). UEs monitor the USD channel at a period that is configured to minimize battery consumption. UEs monitor for changes to SIB13. When the DeviceCategory/Group ID from the USD is signaled on a new SIB13, the UE does an off-schedule check for USD (schedule fragment) changes. A new SIB change with the same ChangeCount does not cause a new USD check. Alternatively, a CBS/PWS or a unicast trigger can indicate the UE to the use of eMBMS for upcoming data download and may include SDP information in the device trigger.

The schedule fragment for the service associated with the DeviceCategory/Group ID is updated with a schedule for the last minute data transfer. The BM-SC 1202 activates the TMGI for the service session and adds DeviceCategory/Group ID to startMBMS Session. SIB13 is updated to include the DeviceCategory/GroupID from the startMBMS Session signaling. The UEs 1212 are paged when SIB13 is changed to cause the UEs to read the USD. Based on the USD schedule fragment, the UEs tune to MCCH to check if the corresponding TMGI is available and then tune to MTCH to receive data being multicast/broadcast.

FIG. 10, FIG. 11 and FIG. 12, thus represent different multicast/broadcast mechanisms using MBMS/eMBMS. In each, a MTC server serves as a content provider and sends data to broadcast multicast service center (BM-SC) at a scheduled time. The UE 1016 wakes up periodically, e.g., once a day, for service announcement or user service description (USD) updates. The UE expects to receive data during the time periods described in the schedule description instance of USD. Once the start time indicated in USD is coming, the UE tunes to multicast control channel (MCCH) and pays attention to MCCH change notification.

In unscheduled instances, a device trigger wakes up the UE. Device triggers may be implemented as one of the following: an existing unicast channel device trigger mechanism (FIG. 10), a CBS/PWS as a group device triggering (FIG. 11) or a SIB13 as group device triggering (device trigger via eMBMS) (FIG. 12). Data class, i.e., group ID, may be included in SIB10, SIB11, SIB12 or SIB13. Device trigger payload indicates eMBMS. One of the device trigger mechanisms specified above can be used to indicate the UE to read USD/MCCH/MTCH. A device trigger may deliver a group specific USD.

For scheduled cases. The MTC server has an agreement with the eMBMS operator regarding the schedule of data downloads and corresponding MTC groups. In these cases the data to be downloaded is sent directly from the MTC server to the BM-SC. The BM-SC has the session schedule and corresponding MTC groups. Once the time to download data is close, the BM-SC sends a session establishment to the MME and MCE through the MBMS-GW.

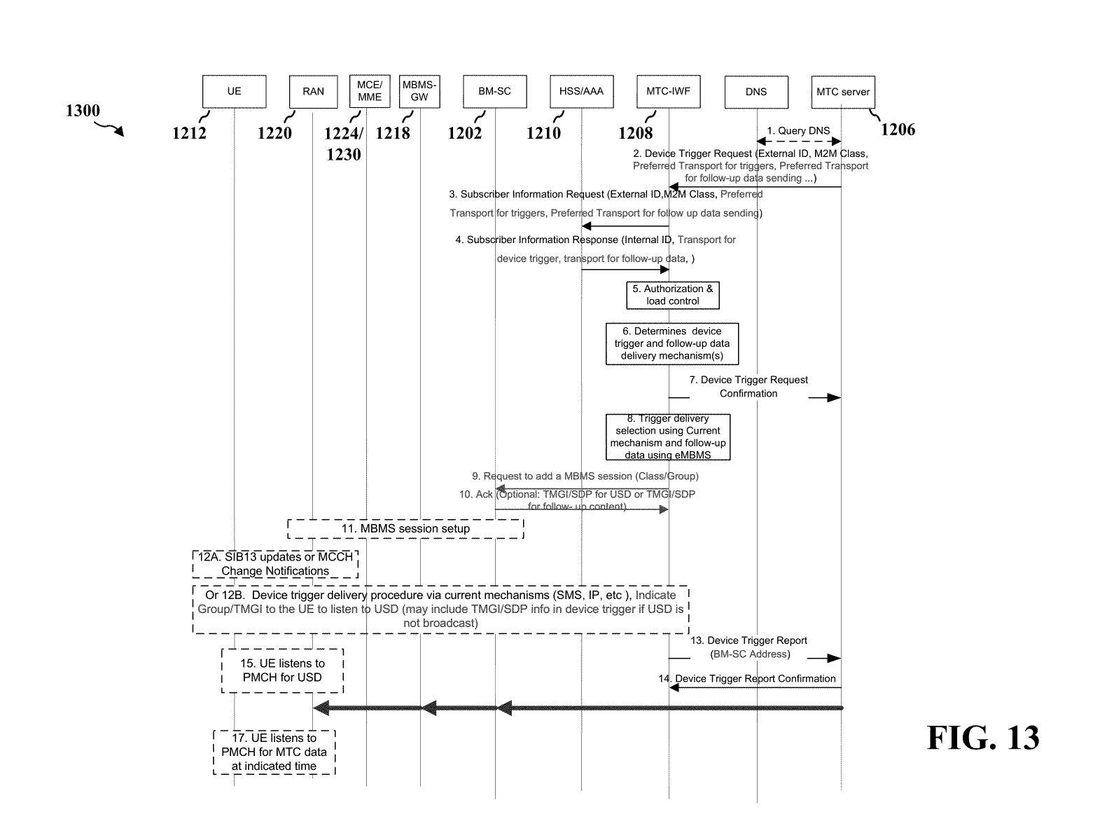

FIG. 13 is a diagram 1300 illustrating an exemplary call flow performed by the MTC architecture of FIG. 12.

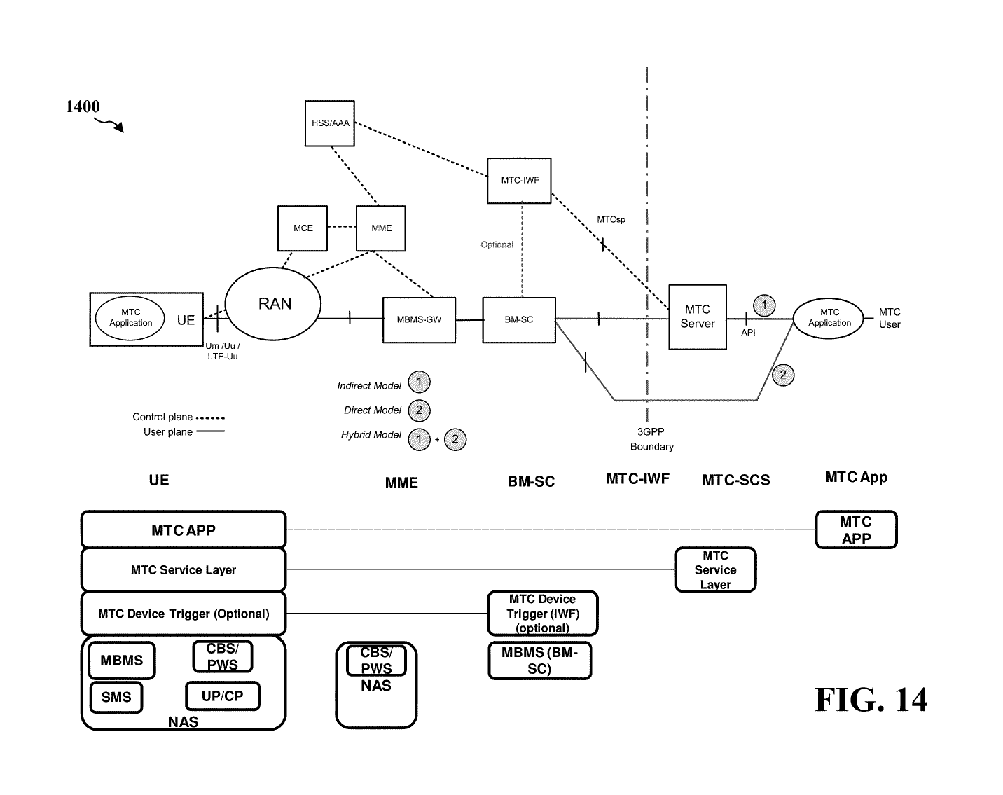

FIG. 14 is a diagram illustrating MTC architecture using eMBMS.

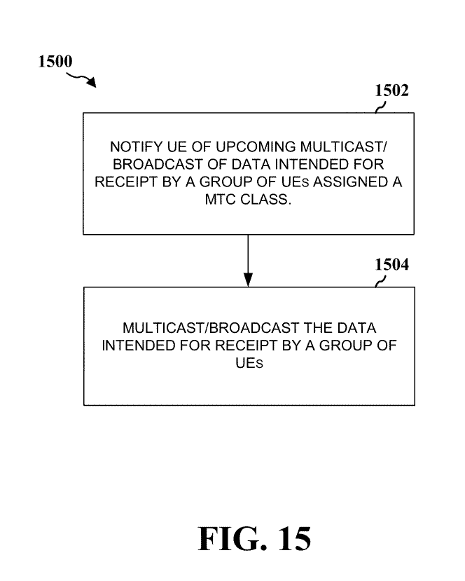

FIG. 15 is a flow chart 1500 of a method of wireless communication. The method may be performed by a broadcast/multicast mechanism. At step 1502, the mechanism notifies a UE of an upcoming multicast/broadcast of data intended for receipt by a group of UEs assigned a MTC class. The UE has one or more MTC classes assigned to it and is configured to awake for the upcoming multicast/broadcast of data if the data to be broadcast corresponds to an MTC class assigned to the UE. At step 1504, the mechanism multicasts/broadcasts the data intended for receipt by a group of UEs.

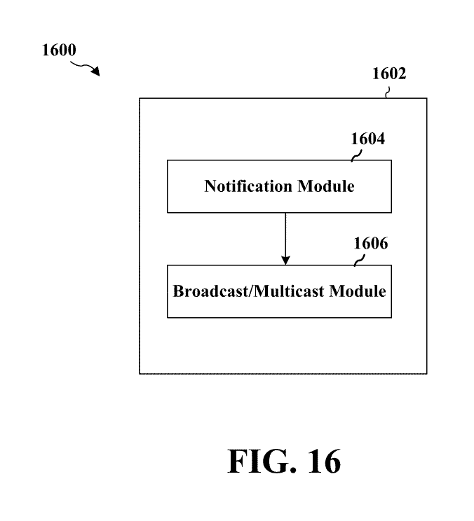

FIG. 16 is a conceptual data flow diagram 1600 illustrating the data flow between different modules/means/components in an exemplary apparatus 1602. The apparatus may be a multicast/broadcast mechanism. The apparatus includes a module 1604 that notifies a UE of an upcoming multicast/broadcast of data intended for receipt by a group of UEs assigned a MTC class. The UE has one or more MTC classes assigned to it and is configured to awake for the upcoming multicast/broadcast of data if the data to be broadcast corresponds to an MTC class assigned to the UE. The apparatus 1602 also includes a module 1606 that multicasts/broadcasts the data intended for receipt by the group of UEs.

The apparatus may include additional modules that perform each of the steps of the algorithm in the aforementioned flow chart of FIG. 15. As such, each step in the aforementioned flow chart of FIG. 15 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

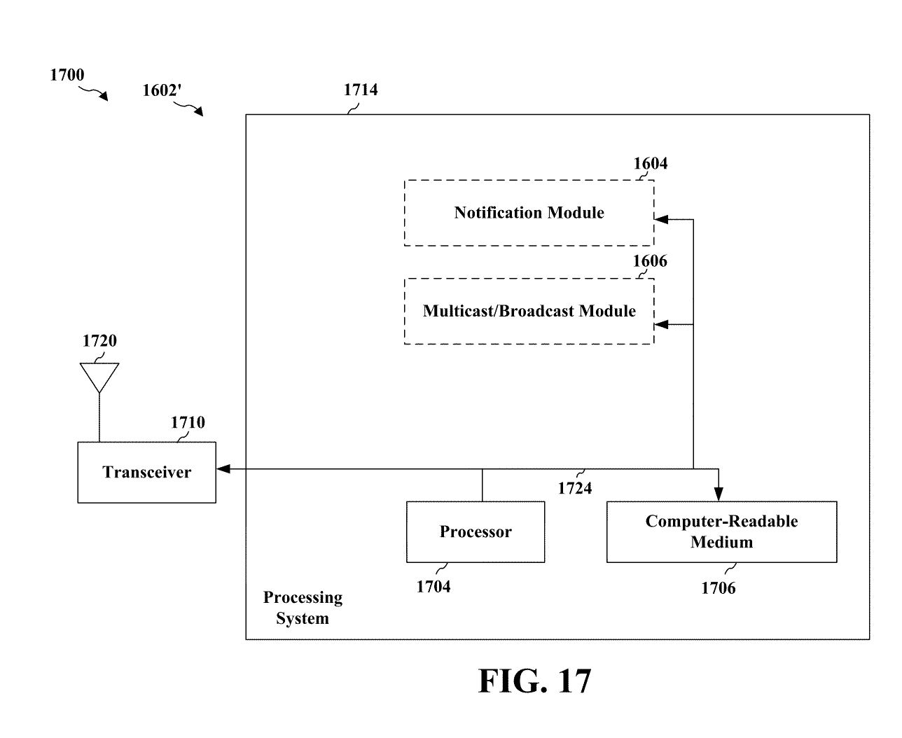

FIG. 17 is a diagram 1700 illustrating an example of a hardware implementation for an apparatus 1602′ employing a processing system 1714. The processing system 1714 may be implemented with a bus architecture, represented generally by the bus 1724. The bus 1724 may include any number of interconnecting buses and bridges depending on the specific application of the processing system 1714 and the overall design constraints. The bus 1724 links together various circuits including one or more processors and/or hardware modules, represented by the processor 1704, the modules 1604, 1606, and the computer-readable medium 1706. The bus 1724 may also link various other circuits such as timing sources, peripherals, voltage regulators, and power management circuits, which are well known in the art, and therefore, will not be described any further.

The processing system 1714 may be coupled to a transceiver 1710. The transceiver 1710 is coupled to one or more antennas 1720. The transceiver 1710 provides a means for communicating with various other apparatus over a transmission medium. The processing system 1714 includes a processor 1704 coupled to a computer-readable medium 1706. The processor 1704 is responsible for general processing, including the execution of software stored on the computer-readable medium 1706. The software, when executed by the processor 1704, causes the processing system 1714 to perform the various functions described supra for any particular apparatus. The computer-readable medium 1706 may also be used for storing data that is manipulated by the processor 1704 when executing software. The processing system further includes at least one of the modules 1604, 1606. The modules may be software modules running in the processor 1704, resident/stored in the computer readable medium 1706, one or more hardware modules coupled to the processor 1704, or some combination thereof.

In one configuration, the apparatus 1602/1602′ for wireless communication includes means for notifying a UE of an upcoming multicast/broadcast of data intended for receipt by a group of UEs assigned a MTC class. The UE has one or more MTC classes assigned to it and is configured to awake for the upcoming multicast/broadcast of data if the data to be broadcast corresponds to an MTC class assigned to the UE. The apparatus 1602/1602′ also includes means for multicasting/broadcasting the data intended for receipt by a group of UEs through at least one multicast/broadcast mechanism. The aforementioned means may be one or more of the aforementioned modules of the apparatus 1902 and/or the processing system 2014 of the apparatus 1902′ configured to perform the functions recited by the aforementioned means.

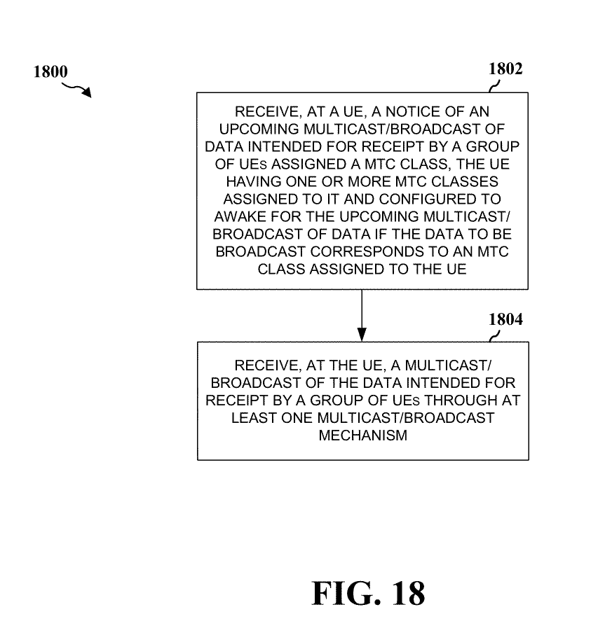

FIG. 18 is a flow chart 1800 of a method of wireless communication. The method may be performed by a UE. At step 1802, the UE receives a notice of an upcoming multicast/broadcast of data intended for receipt by a group of UEs assigned a MTC class. The UE has one or more MTC classes assigned to it and is configured to awake for the upcoming multicast/broadcast of data if the data to be broadcast corresponds to an MTC class assigned to the UE. At step 1804, the UE receives a multicast/broadcast of the data intended for receipt by a group of UEs through at least one multicast/broadcast mechanism.

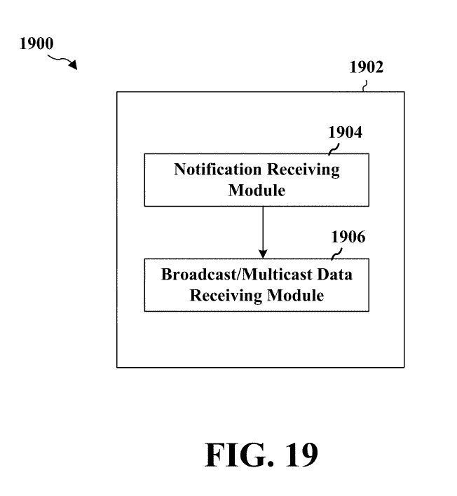

FIG. 19 is a conceptual data flow diagram 1900 illustrating the data flow between different modules/means/components in an exemplary apparatus 1902. The apparatus 1902 may be a UE. The apparatus 1902 includes a module 1904 that receives a notice of an upcoming multicast/broadcast of data intended for receipt by a group of UEs assigned a MTC class. The apparatus 1902 has one or more MTC classes assigned to it and is configured to awake for the upcoming multicast/broadcast of data if the data to be broadcast corresponds to an MTC class assigned to the apparatus. The apparatus 1902 also includes a module 1906 that receives a multicast/broadcast of the data intended for receipt by a group of UEs through at least one multicast/broadcast mechanism.

The apparatus 1902 may include additional modules that perform each of the steps of the algorithm in the aforementioned flow charts of FIG. 18. As such, each step in the aforementioned flow chart of FIG. 18 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

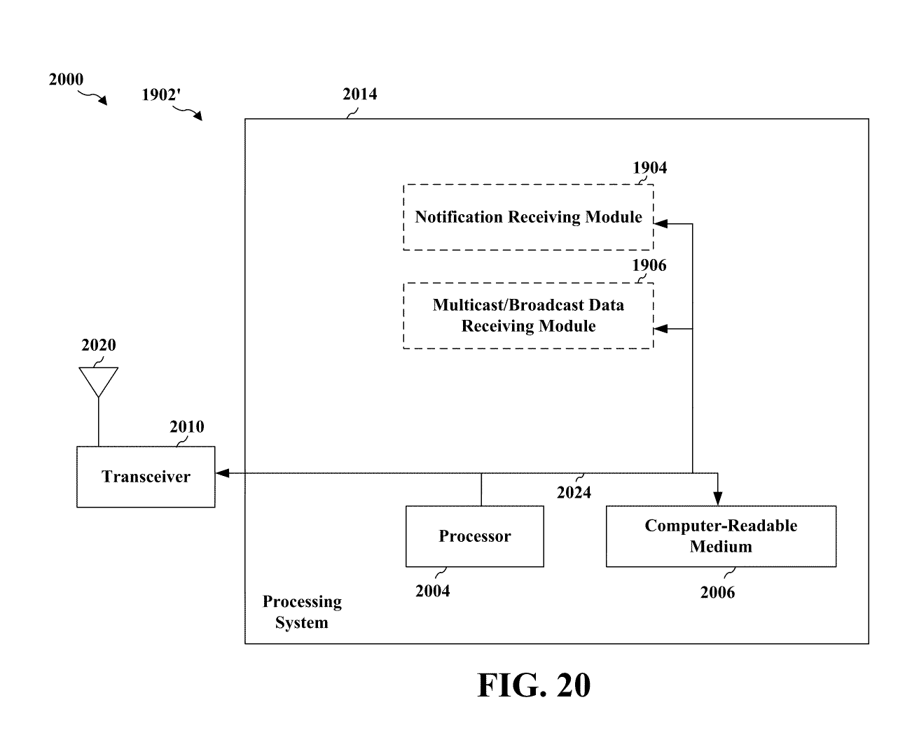

FIG. 20 is a diagram 2000 illustrating an example of a hardware implementation for an apparatus 1902′ employing a processing system 2014. The processing system 2014 may be implemented with a bus architecture, represented generally by the bus 2024. The bus 2024 may include any number of interconnecting buses and bridges depending on the specific application of the processing system 2014 and the overall design constraints. The bus 2024 links together various circuits including one or more processors and/or hardware modules, represented by the processor 2004, the modules 1904, 1906 and the computer-readable medium 2006. The bus 2024 may also link various other circuits such as timing sources, peripherals, voltage regulators, and power management circuits, which are well known in the art, and therefore, will not be described any further.

The processing system 2014 may be coupled to a transceiver 2010. The transceiver 2010 is coupled to one or more antennas 2020. The transceiver 2010 provides a means for communicating with various other apparatus over a transmission medium. The processing system 2014 includes a processor 2004 coupled to a computer-readable medium 2006. The processor 2004 is responsible for general processing, including the execution of software stored on the computer-readable medium 2006. The software, when executed by the processor 2004, causes the processing system 2014 to perform the various functions described supra for any particular apparatus. The computer-readable medium 2006 may also be used for storing data that is manipulated by the processor 2004 when executing software. The processing system further includes at least one of the modules 1904 and 1906. The modules may be software modules running in the processor 2004, resident/stored in the computer readable medium 2006, one or more hardware modules coupled to the processor 2004, or some combination thereof. The processing system 2014 may be a component of the UE 650 and may include the memory 660 and/or at least one of the TX processor 668, the RX processor 656, and the controller/processor 659.

In one configuration, the apparatus 1902/1902′ for wireless communication includes means for receiving a notice of an upcoming multicast/broadcast of data intended for receipt by a group of UEs assigned a machine type communication (MTC) class. The apparatus has one or more MTC classes assigned to it and is configured to awake for the upcoming multicast/broadcast of data if the data to be broadcast corresponds to an MTC class assigned to the apparatus. The apparatus 1902/1902′ also includes means for receiving a multicast/broadcast of the data intended for receipt by a group of UEs through at least one multicast/broadcast mechanism. The aforementioned means may be one or more of the aforementioned modules of the apparatus 1902 and/or the processing system 2014 of the apparatus 1902′ configured to perform the functions recited by the aforementioned means. As described supra, the processing system 2014 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned means.

Broadcast Support for M2M.

Many small M2M devices may need to be woken up at the same time. For example, a utility company may be requesting the devices to upload their current measurement data, or a utility company may want the devices to act on a load shedding demand/response request, e.g. to turn off power hungry appliances such as air conditioners or dishwashers. A broadcast paging mechanism is desirable as unicast paging for each individual device can consume significant network resources.

Utility companies may need to have the capability to send a broadcast message to a group of M2M nodes (e.g. in the smartgrid). In this case, a broadcast message needs to reach intended devices. A response from the devices may or may not be necessary. For example, if the broadcast message relates to a pricing update, a unicast response from the devices is not needed. Alternatively, unicast acknowledgement may be desired (e.g. for D/R situations) within in a certain timeframe. Such acknowledgement may include an ACK indicating a full response is being processed (optional) or an ACK indicating an actual full response. In both cases a time period within which to respond is provided, with full responses having a longer timeframe. Responses, whether only indicating a full response is being processed or indicating a full response, can flood the network and therefore need to be managed well.

Definition of a group of nodes for a utility can be different from a group of nodes within a cellular network. In one case, one utility group corresponds to nodes across multiple cells typically. In the other case, one utility group corresponds to a subset of nodes within a cell.

Enhancements to the MTC server provide Broadcast Service Coordination capability to deliver broadcasts to many M2M devices. The enhanced MTC server: maintains a mapping between utility group(s) and cellular group(s); maintains a list of serviced devices for each utility group; enables different types of broadcast services, such as pricing update, D/R etc.; crafts a broadcast message indicating specific broadcast service and an (absolute) response time (if ACK is desired); creates a header to indicate a coarse indication of type of broadcast message acceptable by the WWAN, for example this can just be a broadcast message with ACK, a broadcast message with no ACK desired, could also indicate that this is a smartgrid-related message.

The enhanced MTC server also: submits messages to cellular network; derives a list of intended devices (from a service perspective) intended to be reached; waits for service layer unicast acknowledgements/responses from intended target devices; maintains a list of devices that have responded if response is desired; retargets broadcast groups or nodes that have not responded; and sends an update to utility company on efficacy of the broadcast request.

In an exemplary broadcasting implementation, a network (WWAN) sends a broadcast page to a group of devices. The page includes a generic group classification identifier associated with an M2M device (C1). The page also provides a staggered time duration (T1) during which a response from the M2M device is desired by the network. The network may rebroadcast the page multiple times to increase the efficiency of the broadcast. The page also includes a broadcast transaction identifier (B1) which is reused if the page is rebroadcast. The three tuple (B1, C1, T1) constitutes the broadcast page request. The network waits for a response from the M2M devices within the time frame suggested

If some of M2M devices do not respond within the time frame, the network can send a new broadcast page with a new broadcast transaction identifier and a new time duration for response. This new page can be rebroadcast multiple times as well to increase the efficiency of the broadcast. Different classes of M2M devices can be targeted with different time durations, where higher priority devices have to respond over a shorter duration, and lower priority devices have to respond over an extended time duration. For example, a multi-class broadcast message could consist of (B1, C1, T1, C2, T2, C3, T3, . . . ), where T is time and T1<T2<T3. Devices of class C1 have to respond within time T1. Devices of class C2 have to respond within time T2 and may respond only in the time T2−T1 for example. Devices of class C3 have to respond within time T3 and may respond only in the time T3−T2 for example. Finally, an optional unicast session may be utilized by the network to reach out to each m2m device that has not responded to the broadcast page attempts

With respect to an M2M device, it receives the broadcast page and identifies that the device classification identifier in the page matches its classification identifier. The device identifies the time duration during which its response is desired. For a multi-class broadcast page, the device identifies the time frame during which its response is desired, e.g., T3−T2 for device class C3. The device selects a random time for transmission within the time frame identified for response. The device communicates back to the network at that random time. If a failure in transmission occurs, the device attempts again at a random time in the remaining time left. If the device fails to communicate within the time allocated, it waits for a new broadcast page from the network with a new broadcast identifier. Alternatively the device waits for a unicast page specific for the device.

With respect to unicast responses, devices could respond over RACH picking a transmission time randomly within their allocated staggered time interval. Devices that received information but which are attempting repair could report their status, for example, as follows: received message, attempting repair; or received message, repair successful. Devices that did not receive any information and which did not receive the broadcast message can be targeted again by the MTC server in a subsequent broadcast message. Different subgroups of devices could target different repair servers to distribute the load on the repair servers when multiple subgroups are targeted simultaneously. Different subgroups of devices could be targeted in different time intervals to alleviate the unicast response congestion load on the network.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1.-28. (canceled)

29. A method of wireless communication comprising:
sending a broadcast/multicast wakeup indication to a user equipment (UE) or a group of UEs of an upcoming multicast/broadcast session, the UE being a member of one or more groups and configured to wake up for the upcoming multicast/broadcast session and receive data during the session, if the data to be multicast/broadcast corresponds to one of the one or more groups; and
multicasting/broadcasting the data intended for receipt by a group of UEs through at least one multicast/broadcast mechanism.

30. The method of claim 29 wherein the at least one multicast/broadcast mechanism comprises LTE MBMS, UMTS MBMS, cdma2000 BCMCS, and other multimedia broadcast and multicast mechanisms.

31. The method of claim 29 wherein the wakeup indication is sent through one of a cell broadcast service/public warning system (CBS/PWS) or a unicast channel, and sending a wakeup indication to a UE comprises sending the information identifying at least one of the group of UEs and a schedule for the multicast/broadcast.

32. The method of claim 31, wherein the information is sent from one or more of a machine type communication (MTC) server, a MTC application and a MTC interworking function (MTC-IWF).

33. The method of claim 31, wherein sending a wakeup indication to a UE further comprises forwarding the information to a radio access network (RAN) for transmission over the RAN.

34. The method of claim 33, wherein the information is sent by one or more of a paging message and a system information block (SIB) transmission.

35. The method of claim 34, wherein the information in the SIB comprises a schedule for the broadcasting of data.

36. The method of claim 31, wherein multicasting/broadcasting the data intended for receipt by a group of UEs data comprises transmitting the data in one or more SIBs through a radio access network (RAN).

37. The method of claim 29, wherein the at least one multicast/broadcast mechanism comprises a multimedia broadcast multicast service (MBMS), and sending a wakeup indication to a UE comprises sending a device trigger to a MTC-IWF, the device trigger including information identifying the group of UEs.

38. The method of claim 37, wherein sending a wakeup indication to a UE further comprises sending the device trigger, from the MTC-IWF and through a RAN, the device trigger further including an indication that MBMS is being used for the multicasting/broadcasting of the data.

39. The method of claim 37, wherein sending a wakeup indication to a UE further comprises sending the device trigger, from a CBE/CBS and through a RAN, the device trigger further including an indication that MBMS is being used for the multicasting/broadcasting of the data.

40. The method of claim 39, wherein the wakeup indication is sent through one or more of SIB10, SIB11 and SIB12.

41. The method of claim 37, wherein sending a wakeup indication to a UE further comprises sending the device trigger, from the MTC-IWF and through a BM-SC and a RAN, the device trigger further including an indication that MBMS is being used for the multicasting/broadcasting of the data.

42. The method of claim 41, wherein the indication is sent through SIB13 updates and MMCH change notifications.

43. The method of claim 37, wherein multicasting/broadcasting the data comprises transmitting the data over a MTCH through a radio access network (RAN).

44. The method of claim 29 wherein the upcoming multicast/broadcast session is unscheduled.

45. A system for wireless communication, comprising:
means for sending a broadcast/multicast wakeup indication to a user equipment (UE) or a group of UEs of an upcoming multicast/broadcast session, the UE being a member of one or more groups and configured to wake up for the upcoming multicast/broadcast session and receive data during the session, if the data to be multicast/broadcast corresponds to one of the one or more groups; and
means for multicasting/broadcasting the data intended for receipt by a group of UEs through at least one multicast/broadcast mechanism.

46. A system for wireless communication, comprising:
a processing system configured to:
send a broadcast/multicast wakeup indication to a user equipment (UE) or a group of UEs of an upcoming multicast/broadcast session, the UE being a member of one or more groups and configured to wake up for the upcoming multicast/broadcast session and receive data during the session, if the data to be multicast/broadcast corresponds to one of the one or more groups; and
multicast/broadcast the data intended for receipt by a group of UEs through at least one multicast/broadcast mechanism.

47. A computer program product, comprising:
a computer-readable medium comprising code for:
sending a broadcast/multicast wakeup indication to a user equipment (UE) or a group of UEs of an upcoming multicast/broadcast session, the UE being a member of one or more groups and configured to wake up for the upcoming multicast/broadcast session and receive data during the session, if the data to be multicast/broadcast corresponds to one of the one or more groups; and
multicasting/broadcasting the data intended for receipt by a group of UEs through at least one multicast/broadcast mechanism.

48. A method of wireless communication of a user equipment (UE) comprising:
receiving, at the UE, a multimedia/broadcast wakeup indication of an upcoming multicast/broadcast session, the UE being a member of one or more groups;
waking up for the upcoming multicast/broadcast session if the data to be multicast/broadcast corresponds to one of the one or more groups; and
receiving a multicast/broadcast of the data intended for receipt by a group of UEs through at least one multicast/broadcast mechanism.

49. The method of claim 48 wherein the wakeup indication is received through one of a cell broadcast service/public warning system (CBS/PWS) or a unicast channel, and the wakeup indication comprises information identifying at least one of the group of UEs and a schedule for the multicast/broadcast.

50. The method of claim 48 wherein the at least one multicast/broadcast mechanism comprises LTE MBMS, UMTS MBMS, cdma2000 BCMCS, and other multimedia broadcast and multicast mechanisms.

51. An apparatus for wireless communication, comprising:
means for receiving a broadcast/multicast wakeup indication of an upcoming multicast/broadcast session, the UE being a member of one or more groups;
means for waking up for the upcoming multicast/broadcast session if the data to be multicast/broadcast corresponds to one of the one or more groups; and
means for receiving a multicast/broadcast of the data intended for receipt by a group of UEs through at least one multicast/broadcast mechanism.

52. An apparatus for wireless communication, comprising:
a processing system configured to:
receive a broadcast/multicast wakeup indication of an upcoming multicast/broadcast session, the UE being a member of one or more groups;
wake up for the upcoming multicast/broadcast session if the data to be multicast/broadcast corresponds to one of the one or more groups; and
receive a multicast/broadcast of the data intended for receipt by a group of UEs through at least one multicast/broadcast mechanism.

53. A computer program product, comprising:
a computer-readable medium comprising code for:
receiving a broadcast/multicast wakeup indication of an upcoming multicast/broadcast session, the UE being a member of one or more groups
waking up for the upcoming multicast/broadcast session if the data to be multicast/broadcast corresponds to one of the one or more groups; and
receiving a multicast/broadcast of the data intended for receipt by a group of UEs through at least one multicast/broadcast mechanism.
